(19) United States
(12) Patent Application Publication
(10) Pub. No.: US 2008/0172259 A1
(43) Pub. Date: Jul. 17, 2008

(54) System and method of underwriting price risk with an insured window contract

(76) Inventor: Charles W. Grant, Oakbank (CA)

Correspondence Address: Charles W. Grant, 81 Lilac Bay, Oakbank, Manitoba, R0E 1J1, omitted

(21) Appl. No.: 11/654,072

(22) Filed: Jan. 17, 2007

(51) Int. Cl. G06Q 40/00

(52) U.S. Cl. 705/4

(57) ABSTRACT

The invention embodies a system and method of underwriting price risk with an insured window contract. The system and method has application in any marketplace where there is a transparent price that exhibits volatility over time. It is applicable to both buyers and sellers facing price risk in the marketplace. A window is established for the contract period which specifies upper and lower price bounds. Market prices outside the window result in a deposit to or withdrawl from an account owned by the participant in the insured window contract. The contingent account may be an actual account in a financial institution (a contingent account) or a virtual account used simply to determine net balance (a balance account). Surpluses or deficits accrue in the account over the duration of the contract. At contract expiry, deficits in such accounts, when they occur, are indemnified by a claim.

### REFERENCES CITED: U.S. PATENT DOCUMENTS

U.S. Pat. No. 6,622,130, September 2003, Shepherd, 705/37

U.S. Pat. No. 6,470,321, October 2002, Cumming, et. al., 705/4

U.S. Pat. No. 6,321,212, November 2001, Lange, 705/37

U.S. Pat. No. 6,157,918, December 2000, Shepherd, 705/37

U.S. Pat. No. 5,970,479, October 1999, Shepherd, 705/37

U.S. Pat. No. 5,202,827, April 1993, Sober, 705/36

U.S. Pat. No. 4,839,804, June 1989, Roberts et al., 705/37

### FIELD OF THE INVENTION

The invention is a system and method of underwriting price risk with an insured window contract. It is in, but not limited to, the fields of financial engineering and financial risk management.

### BACKGROUND OF THE INVENTION

Buyers and sellers in open market economies face price risk if the asset is volatile in price over time. Oftentimes, price coverage is required by buyers and sellers to facilitate planning and operations and to protect profits and balance sheets. The insured window contract gives the buyers and sellers a new method and system to underwrite price risk. Existing methods include financial derivatives like forwards, futures and options, offered in exchange-traded or over-the-counter markets. The insured window contract is an addition to that suite of choices.

### SUMMARY OF THE INVENTION

1. A system and method of underwriting price risk with an insured window contract that comprises the steps of:
(a) Buyers/sellers enter into a contract with an insurer.
(b) At contract inception, buyers/sellers declare a volume of purchases/sales at market prices of the day over the contract period.
(c) Buyers/sellers in the insured window contract elect to either establish, with their financial institution, an operating account and a contingent account (“real” accounts), both fully owned by themselves whether in surplus or deficit, or to establish a “virtual” balance account to track net balances across the contract period without the participation of a financial institution.
(d) An indemnity agreement, exercisable on the date of contract expiry, is entered into between the buyer/seller and the insurer on the inception date, with the buyer/seller paying the premium and being the named insured, and the insurer receiving the premium on the inception date and paying the claim on the expiry date, when required.
(e) The window is set by the insurer and agreed by the insured at the beginning of the contract period for the contract period, such that x⁺ is the top of the window and x⁻ is the bottom of the window.
(f) When the market price x rises above x⁺, the buyer is said to pay the market price x and the difference between x and x⁺ is transferred from the contingent account to the operating account (“real”) or deducted from the balance account (“virtual”).
(g) When the market price rises above x⁺, the seller is said to receive the market price x and the difference between x and x⁺ is transferred from the operating account to the contingent account (“real”) or added to the balance account (“virtual”).
(h) When the market price falls below x⁻, the buyer is said to pay the market price x and the difference between x⁻ and x is transferred from the operating account to the contingent account (“real”) or added to the balance account (“virtual”).
(i) When the market price falls below x⁻, the seller is said to receive the market price x and the difference between x⁻ and x is transferred from the contingent account to the operating account.
(j) When the market price x is between x⁻ and x⁺, the buyer and seller are said to realize their price transactions at x and there is no activity in terms of transfers between the operating account and contingent account (“real”) or adjustments to the balance account (“virtual”).
(k) A surplus in the contingent account at contract expiry is transferred to the operating account to leave the contingent account with zero balance.
(l) A surplus in the balance account (“virtual”) simply indicates that the policy is in a no-claim position.
(m) A deficit in the contingent account (“real”) at contract expiry or negative balance in the balance account (“virtual”) at contract expiry triggers an indemnity and a claim is paid by the insurer to the insured that brings the contingent account (“real”) or balance account (“virtual”) to a zero balance.

### Preferred Embodiments

The invention embodies a system and method of underwriting price risk with an insured window contract. The system and method has application in any marketplace where there is a transparent price that exhibits volatility over time. It is applicable to both buyers and sellers facing price risk in the marketplace.

Buyers/sellers enter into a contract with an insurer. At contract inception, buyers/sellers declare a volume of purchases/sales at market prices of the day over the contract period.

Buyers/sellers in the insured window contract elect to either establish, with their financial institution, an operating account and a contingent account (“real” accounts), both fully owned by themselves whether in surplus or deficit, or to establish a “virtual” balance account to track net balances across the contract period without the participation of a financial institution. An indemnity agreement, exercisable on the date of contract expiry, is entered into between the buyer/seller and the insurer on the inception date, with the buyer/seller paying the premium and being the named insured, and the insurer receiving the premium on the inception date and paying the claim on the expiry date, when required. The window is set by the insurer and agreed by the insured at the beginning of the contract period for the contract period, such that x⁺ is the top of the window and x⁻ is the bottom of the window. When the market price x rises above x⁺, the buyer is said to pay the market price x and the difference between x and x⁺ is transferred from the contingent account to the operating account (“real”) or deducted from the balance account (“virtual”). When the market price rises above x⁺, the seller is said to receive the market price x and the difference between x and x⁺ is transferred from the operating account to the contingent account (“real”) or added to the balance account (“virtual”). When the market price falls below x⁻, the buyer is said to pay the market price x and the difference between x⁻ and x is transferred from the operating account to the contingent account (“real”) or added to the balance account (“virtual”). When the market price falls below x⁻, the seller is said to receive the market price x and the difference between x⁻ and x is transferred from the contingent account to the operating account. When the market price x is between x⁻ and x⁺, the buyer and seller are said to realize their price transactions at x and there is no activity in terms of transfers between the operating account and contingent account (“real”) or or adjustments to the balance account (“virtual”). A surplus in the contingent account at contract expiry is transferred to the operating account to leave the contingent account with zero balance. A surplus in the balance account (“virtual”) simply indicates that the policy is in a no-claim position. A deficit in the contingent account (“real”) at contract expiry or negative balance in the balance account (“virtual”) at contract expiry triggers an indemnity and a claim is paid by the insurer to the insured that brings the contingent account (“real”) or balance account (“virtual”) to a zero balance.

### AN EXAMPLE

The following is a simple mathematical model of the system and method of underwriting price risk with an insured window contract. As with any model, it is an extraction from reality but provides some insight and is an aid to discussion of the insured window.

Let's say market prices over time can be described with the equation,

y=2 sin(x) (1)

where time is measured along the x-axis in units of π and spot price is measured along the y-axis in monetary units. One price cycle is represented by 290 along the x-axis. The window stretches along the y-axis from y=−1 to y=+1. A surplus is accumulated when the spot price is above the window and the producer receives the upper-window price (+1) despite the spot price being higher; a deficit accumulates when the spot price is below the window and the producer receives the lower-window price (−1) despite the spot price being lower. The surplus/deficit are represented by the shaded areas above/below the window.

The area A⁺ above the upper-window and below the spot price represents the surplus; the area A⁻ below the lower window and above the spot price represents the deficit. Due to symmetry of the function, both areas are equal.

The coordinates of the points of intersection of the spot price function, y=2 sin x, and the upper level window, y=1, are determined as follows:

$$2 sin x = 1 \\ sin x = \frac{1}{2} \\ x = {sin}^{- 1} ( \frac{1}{2} ) \\ ( \frac{π}{6} , 1 ) , ( \frac{5}{6} π , 1 ) \qquad ( 2 )$$

The following integration is used to determine the area A⁺ (which is equivalent to A⁻):

$$\begin{matrix}{A}^{+} = {\int }_{\frac{π}{6}}^{\frac{5}{6} π} [ ( 2 sin x ) - 1 ] d x \\ = \{ - 2 cos x - x \} {\vert}_{\frac{π}{6}}^{\frac{5}{6} π} \\ = - ( 2 cos ( \frac{5}{6} π ) - \frac{5}{6} π ) - ( - 2 cos ( \frac{π}{6} ) - \frac{π}{6} ) \\ = ( - 2 ( - \frac{\sqrt{3}}{2} ) - \frac{5}{6} π ] - [ - 2 ( \frac{\sqrt{3}}{2} ) - \frac{π}{6} ) \\ = \sqrt{3} - \frac{5}{6} π + \sqrt{3} + \frac{π}{6} \\ = 2 \sqrt{3} - \frac{2}{3} π \\ = 1.369706513\end{matrix} \qquad ( 3 )$$

The model outlines the processes of measuring surpluses and deficits and illustrates the concept of surplus-deficit balance, both central to our discussion.

Over the duration of the window contract, the cummulative gross income earned is described with the equation:

$$Y ( \begin{matrix}n \\ 1\end{matrix} ) = x {\sum }_{t = 1}^{n} S ( n ) + z {\sum }_{t = 1}^{n} ( ( {S}^{+} - S ( n ) \text{\textbar} S ( n ) > {S}^{+} ) + ( S ( n ) - {S}^{-} \text{\textbar} S ( n ) < {S}^{-} ) ) \qquad ( 4 )$$

where
Y(₁ⁿ)is the cummulative gross income earned over the duration of the window contract,
x is the number of units of stock sold per time period t,
S(n) is the price of the stock at time period n,
S⁺ is the price specified as the top of the window,
S⁻ is the price specified as the bottom of the window,
z is the number of units of stock contracted with the window per time period t.

At contract expiry:

$$\begin{matrix}let \\ W = x {\sum }_{t = 1}^{n} S ( n ) \\ and & ( 5 ) \\ Q = z {\sum }_{t = 1}^{n} ( ( {S}^{+} - S ( n ) \text{\textbar} S ( n ) > {S}^{+} ) + ( S ( n ) - {S}^{-} \text{\textbar} S ( n ) < {S}^{-} ) ) \\ then & ( 6 ) \\ Y ( \overline{n} ) = W + ( Q \text{\textbar} Q \geq 0 ) + ( Q - I ) \text{\textbar} Q < 0 ) ; \\ I = \vert Q \vert . & ( 7 )\end{matrix}$$

where Y( n̅) is the cummulative gross income earned over the contract duration including the end of the contract period and I is the indemnity realized under the insured window should there be a deficit at the end of the contract period.

‘Real-world’ market price movements do not adhere to a nice sin curve as is suggested by the model. The stochastic nature of market prices makes it a challenge to actuarially set the insured window at the outset of the contract. If reality varies from the actuarial projection (the insured window is set too high or too low), the contingent account (“real”) or account balance (“virtual”) could be in surplus or deficit at the time of contract expiry. A deficit will trigger a claim to bring such deficit to a zero balance.

The embodiments of the invention in which an exclusive property of privilege is claimed are defined as follows:

1. A system and method of underwriting price risk with an insured window contract that comprises the steps of:
(a) Buyers/sellers enter into a contract with an insurer.
(b) At contract inception, buyers/sellers declare a volume of purchases/sales at market prices of the day over the contract period.
(c) Buyers/sellers in the insured window contract elect to either establish, with their financial institution, an operating account and a contingent account (“real” accounts), both fully owned by themselves whether in surplus or deficit, or to establish a “virtual” balance account to track net balances across the contract period without the participation of a financial institution.
(d) An indemnity agreement, exercisable on the date of contract expiry, is entered into between the buyer/seller and the insurer on the inception date, with the buyer/seller paying the premium and being the named insured, and the insurer receiving the premium on the inception date and paying the claim on the expiry date, when required.
(e) The window is set by the insurer and agreed by the insured at the beginning of the contract period for the contract period, such that x⁺ is the top of the window and x⁻ is the bottom of the window.
(f) When the market price x rises above x⁺, the buyer is said to pay the market price x and the difference between x and x⁺ is transferred from the contingent account to the operating account (“real”) or deducted from the balance account (“virtual”).
(g) When the market price rises above x⁺, the seller is said to receive the market price x and the difference between x and x⁺ is transferred from the operating account to the contingent account (“real”) or added to the balance account (“virtual”).
(h) When the market price falls below x⁻, the buyer is said to pay the market price x and the difference between x⁻and x is transferred from the operating account to the contingent account (“real”) or added to the balance account (“virtual”).
(i) When the market price falls below x⁻, the seller is said to receive the market price x and the difference between x⁻ and x is transferred from the contingent account to the operating account.
(j) When the market price x is between x⁻ and x⁺, the buyer and seller are said to realize their price transactions at x and there is no activity in terms of transfers between the operating account and contingent account (“real”) or adjustments to the balance account (“virtual”).
(k) A surplus in the contingent account at contract expiry is transferred to the operating account to leave the contingent account with zero balance.
(l) A surplus in the balance account (“virtual”) simply indicates that the policy is in a no-claim position.
(m) A deficit in the contingent account (“real”) at contract expiry or negative balance in the balance account (“virtual”) at contract expiry triggers an indemnity and a claim is paid by the insurer to the insured that brings the contingent account (“real”) or balance account (“virtual”) to a zero balance.

2. The system and method in claim 1, wherein said buyers/sellers include, but are not limited to, buyers/sellers of stocks, commodities, currencies and/or any other security or non-security that has a market price that is volatile and transparent.
